(19) United States
(12) Patent Application Publication
(10) Pub. No.: US 2017/0169966 A1
(43) Pub. Date: Jun. 15, 2017

(54) COMPONENT, PUSH SWITCH INCLUDING COMPONENT, PUSH SWITCH, AND ELECTRONIC DEVICE INCLUDING PUSH SWITCH

(71) Applicants: CITIZEN ELECTRONICS CO., LTD., Yamanashi-ken (JP); CITIZEN WATCH CO., LTD., Tokyo (JP)

(72) Inventors: Toshiya NISHIMURO, Otsuki-shi (JP); Yoichi WAKEBE, Tsuru-shi (JP); Kenshi AIHARA, Fujiyoshida-shi (JP)

(21) Appl. No.: 15/375,613

(22) Filed: Dec. 12, 2016

Related U.S. Application Data
(60) Provisional application No. 62/266,631, filed on Dec. 13, 2015.

(51) Int. Cl. H01H 13/14; H01H 13/83; H01H 13/80; H01H 13/02

(52) U.S. Cl. CPC H01H 13/14; H01H 13/023; H01H 13/83; H01H 13/80

(57) ABSTRACT

In a first aspect of the present disclosure, a component includes a frame that includes an upper surface, a lower surface, and an inner surface demarcating an opening; a cover arranged on the upper surface of the frame and covering the opening from above to form a recessed portion at the opening of the frame; a first resilient member; and a second resilient member arranged in the recessed portion at the opening of the frame to be over the first resilient member that is arranged across the opening of the frame and held by the frame.

### CROSS-REFERENCE TO RELATED APPLICATION

This application is a new U.S. patent application that claims benefit of U.S. provisional application No. 62/266,631 filed on Dec. 13, 2015, the disclosures of which are incorporated herein by reference in its entirety.

### BACKGROUND OF THE INVENTION

Field of the Invention

The present disclosure relates to a component, a push switch including the component, a push switch, and an electronic device including the push switch including the component and/or the push switch.

Various electronic devices include push switches. Various electronic devices maybe personal computers, portable communication devices, wearable devices, game consoles, and consumer electronics, for example. Also, push switches may be used in vehicles.

Description of the Related Art

It is open to the public that a conventional key switch device includes a key top; a base plate; a pantograph portion including an upper inner-side shaft member, an upper outer-side shaft member, a lower inner-side shaft member, and a lower outer-side shaft that are connected by connecting pins; and a resiliently supporting structure that supports the key top upward (For reference, see Japanese Unexamined Patent Application Publication Nos. 2013-93230, 2014-600082 and 2014-60083, for example).

Also, it is open to the public that a conventional push switch and/or switch module includes a substrate; a first fixed contact arranged on a surface of the substrate; a second fixed contact that is arranged around the first fixed contact; an upper spring including a convex dome shape and being arranged on the second fixed contact; and a lower spring arranged below the upper spring on the surface of the substrate (For reference, see International Patent Application Publication No. WO 2014/175446, for example).

### SUMMARY OF THE INVENTION

In a first aspect of the present disclosure, a component includes a frame that includes an upper surface, a lower surface, and an inner surface demarcating an opening; a cover arranged on the upper surface of the frame and covering the opening from above to form a recessed portion at the opening of the frame; a first resilient member; and a second resilient member arranged in the recessed portion at the opening of the frame to be over the first resilient member that is arranged across the opening of the frame and held by the frame.

In a second aspect of the present disclosure, a push switch includes a first resilient member; and a second resilient member arranged over the first resilient member, and the first resilient member includes a metallic strip, and the metallic strip of the first resilient member includes a first end crossing an outline of the second resilient member and a second end crossing the outline of the second resilient member.

### BRIEF DESCRIPTION OF THE DRAWING

FIG. 1A shows a top perspective view of a push switch according to a first embodiment.

FIG. 1B shows a top perspective view of a push switch with a pressing member, which is shown in FIG. 1A, removed from the push switch.

FIG. 1C shows a bottom perspective view of a push switch according to the first embodiment.

FIG. 1D shows a top plan view of a substrate 5, on which a push switch according to the first embodiment is mountable.

FIG. 2A shows a top perspective view of a push switch according to a second embodiment of the subject matter.

FIG. 2B shows a top perspective view of a push switch with a pressing member, which is shown in FIG. 2A, removed from the push switch.

FIG. 2C shows a bottom perspective view of a push switch according to the second embodiment.

FIG. 2D shows a cross-sectional view of a push switch taken along a straight line shown in FIG. 2B.

FIG. 2E shows a top perspective view of a substrate 5, on which a push switch according to the second embodiment is mountable, for example.

FIG. 3A shows a top perspective view of a push switch according to a third embodiment of the subject matter. In this embodiment, the push switch may include a substrate.

FIG. 3B shows a top perspective view of a push switch, with a pressing member, which is shown in FIG. 3A, removed from the push switch. In this embodiment, the push switch may include a balancing member.

FIG. 3C shows a bottom perspective view of a push switch according to the third embodiment.

FIG. 3D shows a cross-sectional view of a push switch taken along a straight line shown in FIG. 3B.

FIG. 3E shows a top perspective view of a push switch, with a cover and a balancing member removed from the push switch shown in FIG. 3B.

FIG. 3F shows a top perspective view of a push switch, with the second resilient member is removed from the push switch shown in FIG. 3E.

FIG. 4A shows a top perspective view of a push switch according to a fourth embodiment of the subject matter.

FIG. 4B shows a top perspective view of a push switch with a pressing member, which is shown in FIG. 4A, removed from the push switch. The push switch in this embodiment may include a balancing member.

FIG. 4C shows a bottom perspective view of a push switch, which is shown in FIG. 4B.

FIG. 4D shows a cross-sectional view of a push switch taken along a straight line shown in FIG. 4B.

FIG. 4E shows a bottom perspective view of a push switch, with a balancing member removed from the push switch shown in FIG. 4C.

FIG. 4F shows a top perspective view of a substrate, on which a push switch according to the fourth embodiment is mountable, for example.

FIG. 5A shows a top perspective view of a push switch according to a fifth embodiment of the subject matter.

FIG. 5B shows a top perspective view of a push switch, with a pressing member, which is shown in FIG. 5A, removed from the push switch.

FIG. 5C shows a bottom perspective view of a push switch, shown in FIG. 5B.

FIG. 6A shows a configuration of a balancing member included in the push switch according to the second embodiment of the subject matter. Also, the balancing member shown in FIG. 6A is included in the push switch shown in the third embodiment. FIG. 6A shows the configuration of the balancing member in a condition that a pressing force is applied to the balancing member. FIG. 6A (a) shows a side view of the balancing member. FIG. 6A (b) shows a top perspective view of the balancing member, showing the first part, the second part, and a linkage that connects the first part and the second part.

FIG. 6B shows the configuration of the balancing member that is in a condition free from a pressing force that is applicable to the balancing member from above. FIG. 6B (a) shows a side view of the balancing member, showing the first part and the second part tilting with an angle on the linkage. FIB. 6B (b) shows a top perspective view of the balancing member.

FIG. 7A shows another configuration of a balancing member included in the push switch according to the fourth embodiment of the subject matter. Also, the balancing member shown in FIG. 7A is included in the push switch according to the fifth embodiment of the subject matter. FIG. 7A shows the configuration of the balancing member in a condition that a pressing force is applied to the balancing member from above. FIG. 7A (a) shows a side view of the balancing member, showing a first part, a first linkage and a second linkage that connect the first part and the second part that is smaller in size than the first part and positioned inside the first part that includes a first frame-shape. FIG. 7A (b) shows a top perspective view of the balancing member, showing the first part including a first frame-shape, the second part including a second frame-shape, and the linkage.

FIG. 7B shows the configuration of the balancing member that is in a condition free from a pressing force that is applicable to the balancing member from above. FIG. 7B (a) shows a side view of the balancing member and FIG. 7B (b) shows a top perspective view of the balancing member, showing the first part and the second part tilting with an angle on the linkage.

### DETAILED DESCRIPTION OF EMBODIMENTS

As used herein, the term “and/or” includes any and all combinations of one or more of the associated listed items.

The terminology used herein is for the purpose of describing particular embodiments only and is not intended to be limiting of the subject matter. As used herein, the singular forms “a”, “an” and “the” are intended to include the plural forms as well, unless the context clearly indicates otherwise.

As illustrated in the figures submitted herewith, some sizes of structures or portions may be exaggerated relative to other structures or portions for illustrative purposes. Relative terms such as “below” or “above” or “upper” or “lower” may be used herein to describe a relationship of one element, layer or region to another element, layer or region as illustrated in the figures. It will be understood that these terms are intended to encompass different orientations of a device in addition to the orientation depicted in the figures.

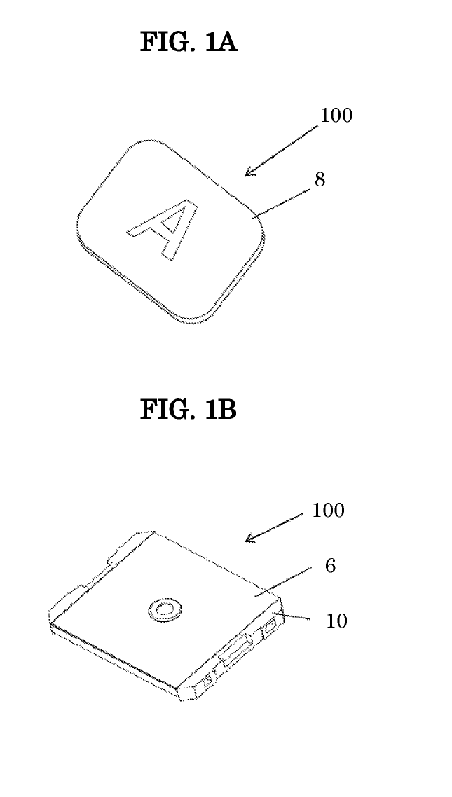

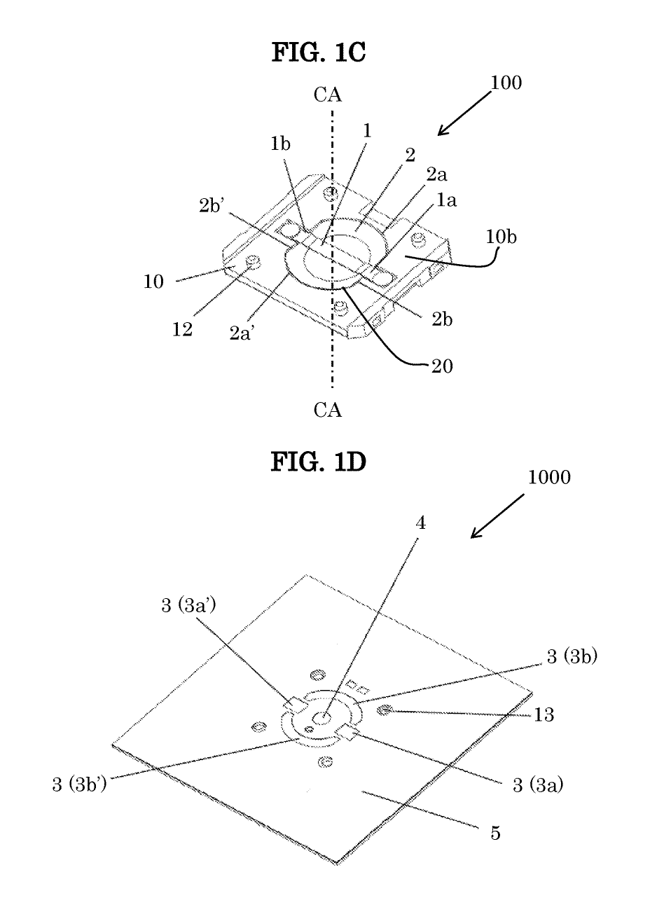

FIG. 1A shows a top perspective view of a push switch 100 according to a first embodiment of the subject matter. A pressing member may include a sign, however, the sign “A” on the pressing member 8 shown in Figures herein is just an example. The sign may be a character, a number, and/or a required indication. Also, such a sign depends on a design of an electronic device in which a push switch is arranged, and therefore, may be not necessary.

FIG. 1B shows a top perspective view of a push switch 100 with a pressing member 8, which is shown in FIG. 1A, removed from the push switch.

FIG. 1C shows a bottom perspective view of a push switch according to the first embodiment.

A push switch 100 according to the first embodiment includes a first resilient member 1, a second resilient member 2 arranged over the first resilient member 1. The first resilient member 1 includes a metallic strip. The second resilient member 2 may be made of metal. The metallic strip of the first resilient member 1 includes a first end 1a crossing an outline 20 of the second resilient member 2 and a second end 1b crossing the outline 20 of the second resilient member 2. The first end 1a and the second end 1b may be opposite ends of the first resilient member 1.

The outline 20 of the second resilient member 2 may include a first arc portion 2a, a second arc portion 2a′, a first straight line portion 2b and a second straight line portion 2b′. The first end 1a of the metallic strip of the first resilient member 1 crosses the first straight line portion 2b of the outline 20 of the second resilient member 2. The second end 1b of the metallic strip of the first resilient member 1 crosses the second straight line portion 2b′ of the outline 20 of the second resilient member 2. The first arc portion 2a and the second arc portion 2a′ maybe positioned opposite to each other. The first straight line portion 2b and the second straight line portion 2b′ of the second resilient member 2 maybe positioned opposite to each other. The second resilient member 2 may be arranged to overlap the first resilient member 1. The second resilient member 2 may be a spring plate, which is made of metal. The second resilient member 2 may include a dome shape.

The configuration and/or arrangement of the first resilient member 1 and the second resilient member 2 aim to electrically mount a push switch on a substrate with a double electrical contact.

The first end 1a of the metallic strip of the first resilient member 1 crosses the first straight line portion 2b of the outline 20 of the second resilient member 2. The second end 1b of the metallic strip of the first resilient member 1 crosses the second straight line portion 2b′.

The push switch 100 in this embodiment may further include a frame 10. The frame 10 may include an upper surface 10a, a lower surface 10b, an inner surface 10c demarcating an opening. The push switch 100 may further include a cover 6 that is arranged on the upper surface 10a of the frame 10 and that covers the opening from above to form a recessed portion 11 at the opening of the frame 10. The second resilient member 2 is arranged in the recessed portion 11. The first resilient member 1 is arranged across the opening of the frame 10 and held by the frame 10.

The frame 10 may include a projection 12 on a lower surface 10b of the frame 10. The projection 12 of the lower surface 10b of the frame 10 may be used to position the push switch 100 on a substrate 5.

FIG. 1D shows a top plan view of a substrate 5, on which the switch according to the first embodiment is mountable. The substrate 5 may include a hole 13 to receive the projection of the frame 10. In this embodiment, there are four projections 12 on the lower surface 10b of the frame 10, and there are four holes 13 in the substrate 5. The push switch 100 maybe attached to the substrate 5 by caulking the holes 13 of the substrate 5 with the projections 12. Also, the push switch may be attached to the substrate 5 by fastening a screw. Furthermore, the push switch may be adhered to the substrate by an adhesive. The push switch may be adhered to the substrate by a double-sided tape. If the push switch is attached to the substrate 5 by thermal caulking the holes 13 of the substrate 5 with the projections 12, it is possible to attach the push switch to the substrate 5 without increasing the number of switch components.

The substrate 5 may belong to an electronic device 1000. Electrodes arranged on and/or in the substrate 5 may include a first electrode 3 and the second electrode 4. The first electrode 3 (3a), 3 (3a′), 3 (3b), 3 (3b′) are electrically connected to each other on and/or inside the substrate 5. One or more push switches may be mounted on a substrate. The push switch 100 including a first resilient member 1 and a second resilient member 2 that are arranged on the frame 10 is electrically mountable on a first electrode 3 and a second electrode 4 of the substrate 5. The first resilient member 1 is made of an electrically-conductive material. The first resilient member 1 maybe a metallic strip. The second resilient member 2 is made of an electrically-conductive material. As shown in FIG. 1C, the center of the first resilient member 1 and the center of the second resilient member 2 are aligned on a center axis CA of the push switch 100.

The first resilient member 1 of the push switch 100 may be arranged on a first electrode 3 (3a) and 3 (3a′) over a second electrode 4. The second electrode 4 may be aligned on a center axis CA of the push switch 100. The second resilient member 2 may be arranged on the first electrode 3 (3b) and 3 (3b′)and may cover the first resilient member 1 except the first end 1a of the metallic strip of the first resilient member 1 and the second end 1b of the metallic strip of the first resilient member 1 that is arranged over the second electrode 4.

The term “double electrical contact” herein means an electrical connection between a first electrode 3 and a second electrode 4 by a first resilient member 1 and also by a second resilient member 2. A push switch with a “double electrical contact” by the first resilient member 1 and the second resilient member 2 that are different from each other in shape and/or size may obtain the electrical connection between the first electrode 3 and the second electrode 4 of the push switch more securely, compared to a push switch with a single resilient member for an electrical connection between the first electrode 3 and the second electrode 4.

Even if a foreign substance accidentally enters between the first resilient member and the second resilient member, an electrical connection will be secured by applying a pressing force to the second resilient member 2 through the pressing member 7 from above.

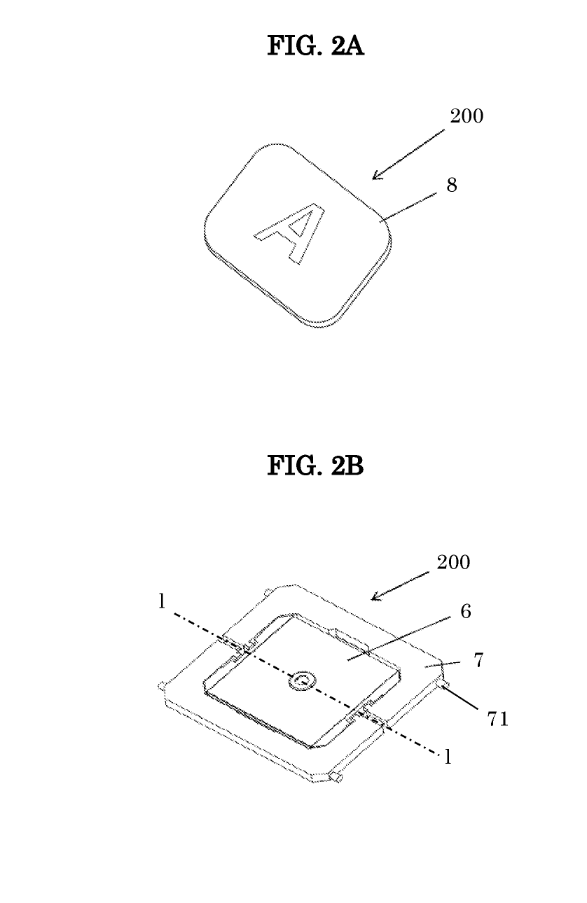

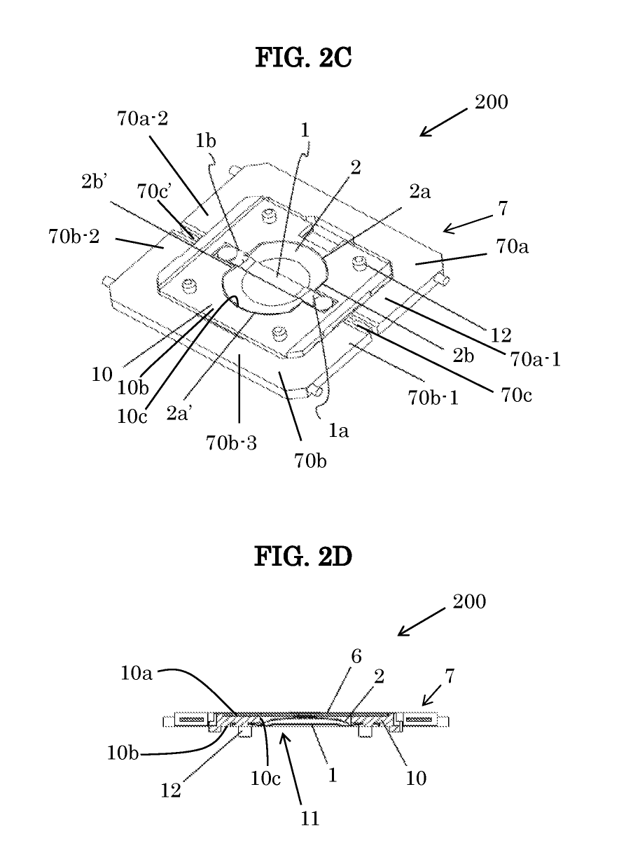

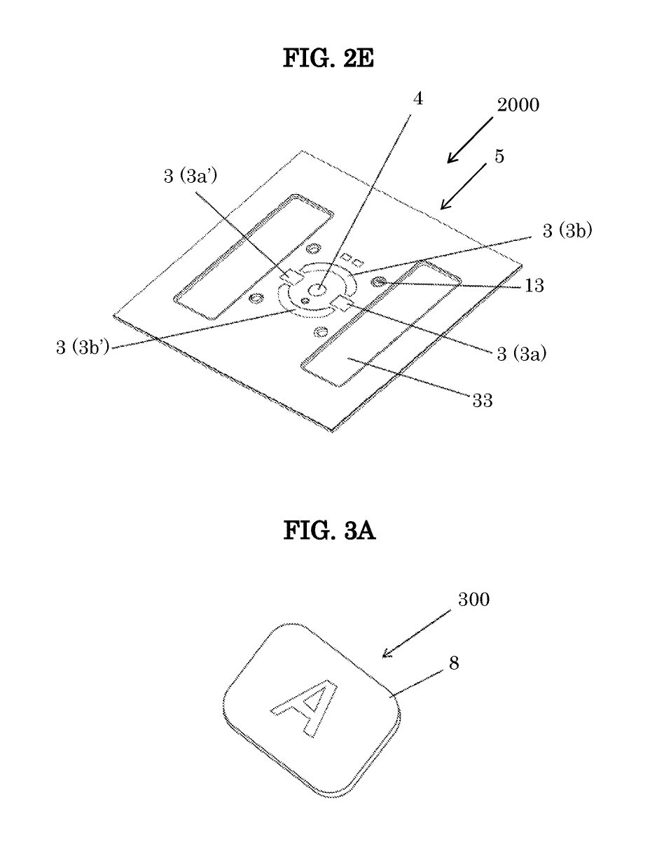

FIG. 2A shows a top perspective view of a push switch according to a second embodiment of the subject matter.

FIG. 2B shows a top perspective view of a push switch with a pressing member 8, which is shown in FIG. 2A, removed from the push switch 200.

FIG. 2C shows a bottom perspective view of a push switch shown in FIG. 2B.

FIG. 2D shows a cross-sectional view of a push switch taken along a straight line shown in FIG. 2B.

A push switch 200 according to the second embodiment includes a first resilient member 1, a second resilient member 2 arranged over the first resilient member 1, and a pressing member 8 arranged above the second resilient member 2. The first resilient member 1 includes a metallic strip. The metallic strip of the first resilient member 1 includes a first end 1a crossing an outline 20 of the second resilient member 2 and a second end 1b crossing the outline 20 of the second resilient member 2.

The push switch 200 in this embodiment may further include a frame 10, similarly to the first embodiment. The frame 10 may include an upper surface 10a, a lower surface 10b, an inner surface 10c demarcating an opening. The push switch 100 may further include a cover 6 that is arranged on the upper surface 10a of the frame 10 and that covers the opening from above to form a recessed portion 11 at the opening of the frame 10. The second resilient member 2 is arranged in the recessed portion 11. The first resilient member 1 is arranged across the opening of the frame 10 and held by the frame 10. The first resilient member 1 may be held by the frame 10. The first resilient member 1 may be held by the frame 10 by fastening a screw at the first end 1a of the first resilient member 1 and fastening a screw at the second end 1b of the first resilient member 1. Also, the first resilient member 1 may be held by the frame 10 by thermal caulking a hole at the first end 1a of the first resilient member 1 with a projection of the frame 10 and by thermal caulking a hole at the second end 1b of the first resilient member 1 with a projection of the frame 10, for example. Furthermore, the first resilient member 1 may be adhered to the frame 10 by an adhesive, for example. The first resilient member 1 may be adhered to the substrate by a double-sided tape, for example.

In this embodiment, the push switch 200 further includes a balancing member 7 shown as a first embodiment of the balancing member 7. The balancing member 7 may support the pressing member 8 to be balanceable when a pressing force is applied to the pressing member 8 from above. The balancing member 7 may support the pressing member not to tilt.

The balancing member 7 in this embodiment includes a first part 70a, a second part 70b, and a linkage 70c (70c′) connecting the first part 70a and the second part 70b. The first part 70a and the second part 70b of the balancing member 7 are angle-variable on the linkage 70c (70c′).

In this embodiment, the first part 70a of the balancing member 7 includes a U-shape. The second part 70b of the balancing member 7 includes a U-shape, and the first part 70a of the balancing member 7 and the second part 70b of the balancing member 7 are connected by the linkage 70c (70c′) to form a frame-shape with an opening 70d, in which the frame 10 is held.

The balancing member 7 supports the pressing member 8. The first part 70a of the balancing member 7 and the second part 70b of the balancing member 7 are angle-variable on the linkage 70c (70c′) to be flat to each other when the pressing member 8 is pressed down from above. The balancing member 7 may include one or more projections 71 at an outer peripheral surface 7d and/or an inner surface 7c. The one or more projections 71 at the outer peripheral surface 7d of the balancing member 7 may be used to connect to the pressing member 8. The one or more projections at the inner surface 7c of the balancing member 7 may be used to connect and/or support the frame 10 in which the first resilient member 1 and the second resilient member 2 are arranged.

FIG. 2E shows a top perspective view of a substrate 5, on which the push switch 200 according to the second embodiment is mountable, for example. The substrate 5 may belong to an electronic device 2000. The substrate 5 may include another opening 33 and/or recessed portion except holes 13 for positioning and/or holding the push switch on the substrate. Such an opening and/or recessed portion may be used to arrange a part of the push switch. The substrate 5 may include a lead frame.

In this embodiment, the first part 70a of the balancing member includes a U-shape. The first part 70a of the balancing member 7 includes a first arm portion 70a-1, a second arm portion 70a-2 and a connecting portion 70a-3 connecting the first arm portion 70a-1 and the second arm potion 70a-2 to form the U-shape.

Also, the second part 70b of the balancing member 7 includes a U-shape. The second part 70b of the balancing member 7 includes a first arm portion 70b-1, a second arm portion 70b-2, and a connecting portion 70b-3 connecting the first arm portion 70b-1 and the second arm portion 70b-2.

The first part 70a and the second part 70b are connected at ends of the first arm portions 70a-1 and 70b-1 through a first linkage 70c and at ends of the second arm portions 70a-2 and 70b-2 through a second linkage 70c′. The first part 70a and the second part 70b connected by the first linkage 70c and the second linkage 70c′ that are on a straight line 1-1 forms a frame shape with an opening 70d.

The frame 10 holding the first resilient member 1 and the second resilient member 2 at an opening with a cover 6 that is arranged on an upper surface of the frame 10 and that closes the opening 10d to form the recessed portion is held in the opening 70d of the balancing member 7. The frame 10 may be held at the first arm portions 70a-1 and 70b-1 and the second arm portions 70a-2 of the first part 70a and the second part 70b.

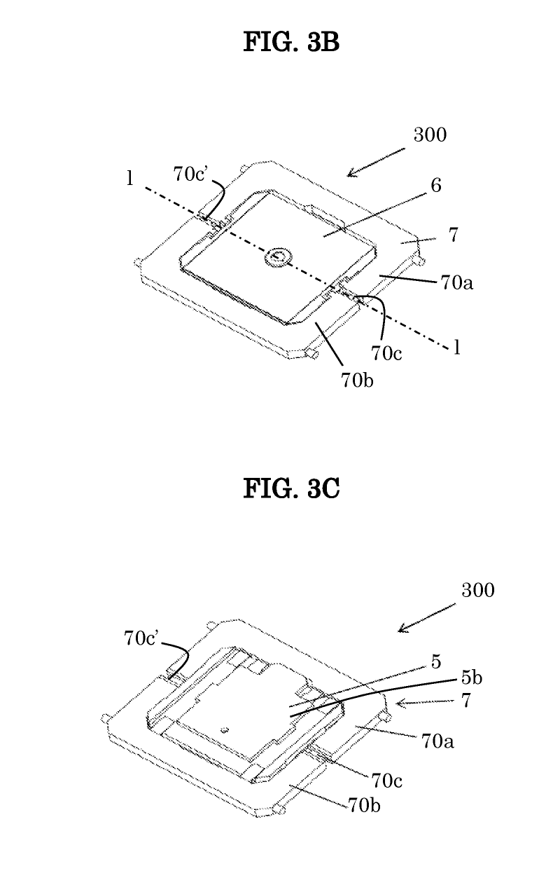

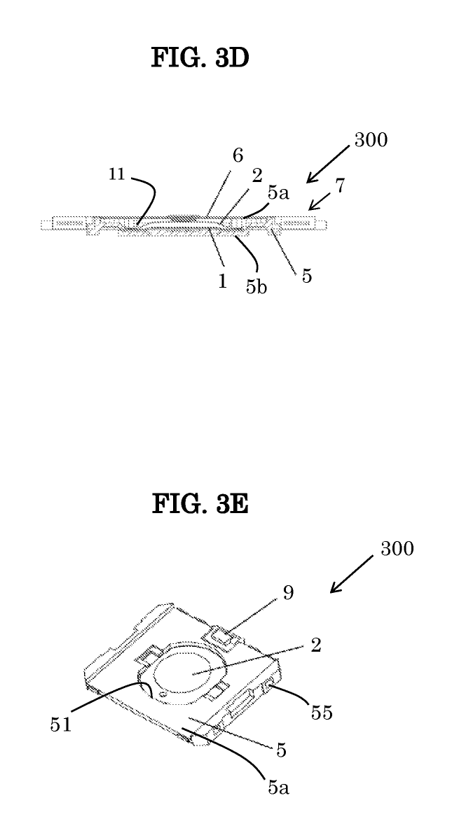

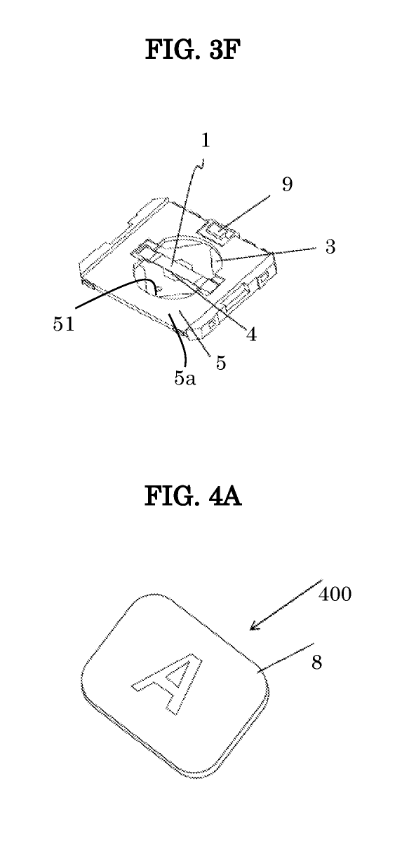

FIG. 3A shows a top perspective view of a push switch according to a third embodiment of the subject matter. In this embodiment, the push switch 300 may include a substrate 5.

A push switch 300 according to the second embodiment includes a first resilient member 1, a second resilient member 2 arranged over the first resilient member 1, and a pressing member 8 arranged above the second resilient member 2. The first resilient member 1 includes a metallic strip. The metallic strip of the first resilient member 1 includes a first end 1a crossing an outline 20 of the second resilient member 2 and a second end 1b crossing the outline 20 of the second resilient member 2.

The push switch 300 in this embodiment may further include a balancing member 7, similarly to the second embodiment. However, the push switch 300 does not include a frame 10 shown in FIG. 2C but include a substrate 5. The substrate 5 in this embodiment belongs to the push switch 300.

FIG. 3B shows a top perspective view of a push switch, with a pressing member 8, which is shown in FIG. 3A, removed from the push switch 300. In this embodiment, the push switch 300 may include a balancing member 7.

FIG. 3C shows a bottom perspective view of a push switch 300 with a lower surface 5b of a substrate 5, shown in FIG. 3B.

FIG. 3D shows a cross-sectional view of a push switch taken along a straight line 1-1 shown in FIG. 3B. The substrate 5 includes electrodes including a first electrode 3 and a second electrode 4, and a recessed portion 51. The push switch 300 may include a light-emitting element 9 that is electrically mounted on the substrate. The push switch 300 further includes a cover 6 that is arranged on the upper surface 5a of the substrate 5 and that covers the recessed portion from above. The light-emitting element 9 may be arranged adjacent to the cover 6. The cover 6 may include a light-transmitting member. The cover 6 may be made of a light-transmitting member to transmit light from the light-emitting element. Also, the balancing member 7 may include a light-transmitting member. The balancing member 7 may be made of a light-transmitting member to transmit light from the light-emitting element 9. The light-emitting element 9 may be a light-emitting diode.

The second resilient member 2 is arranged in the recessed portion of the substrate 5 and electrically arranged on the first electrode 3 over the first resilient member 1 that is electrically arranged on the first electrode 3 over the second electrode 4. The first resilient member 1 is arranged in the recessed portion of the substrate 5 under the second resilient member 2, as shown in FIG. 3D.

FIG. 3E shows a top perspective view of a push switch, with the cover 6 and the balancing member 7 removed from the push switch 300 shown in FIG. 3B.

FIG. 3F shows a top perspective view of a push switch, with the second resilient member 2 is removed from the push switch 300 shown in FIG. 3E.

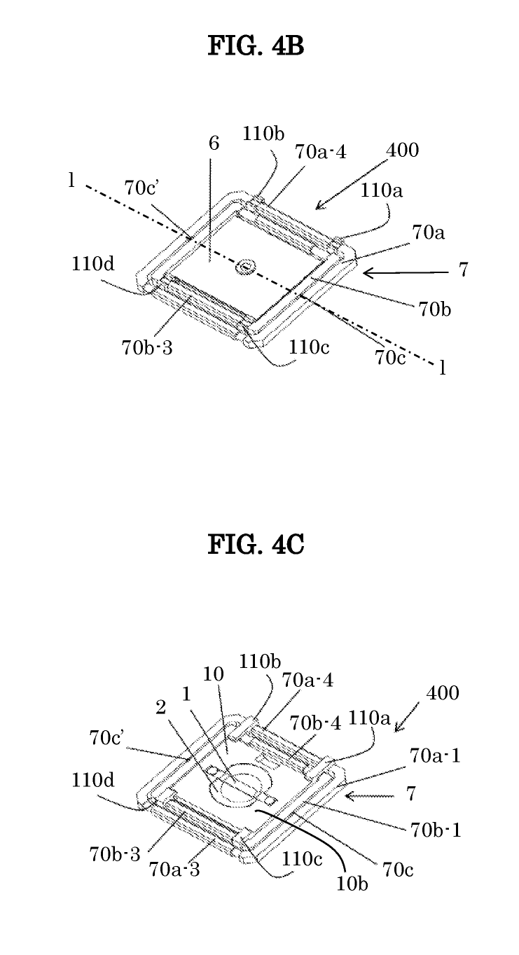

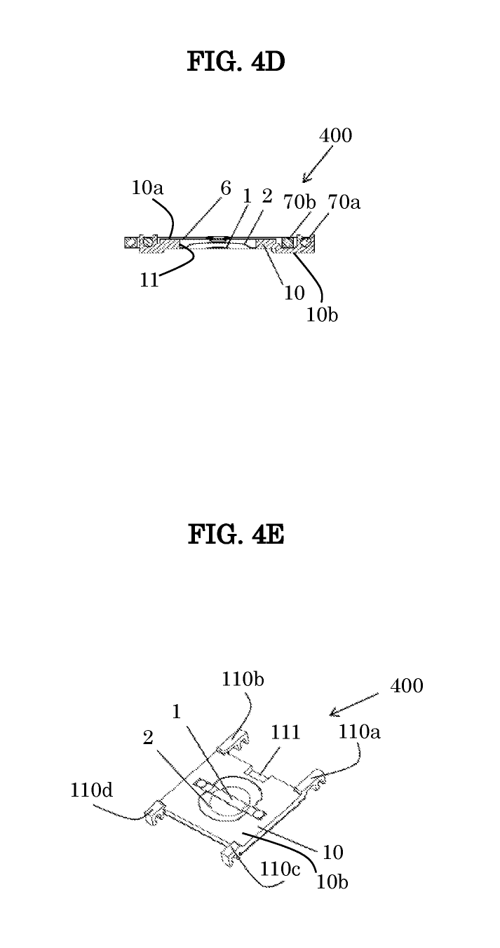

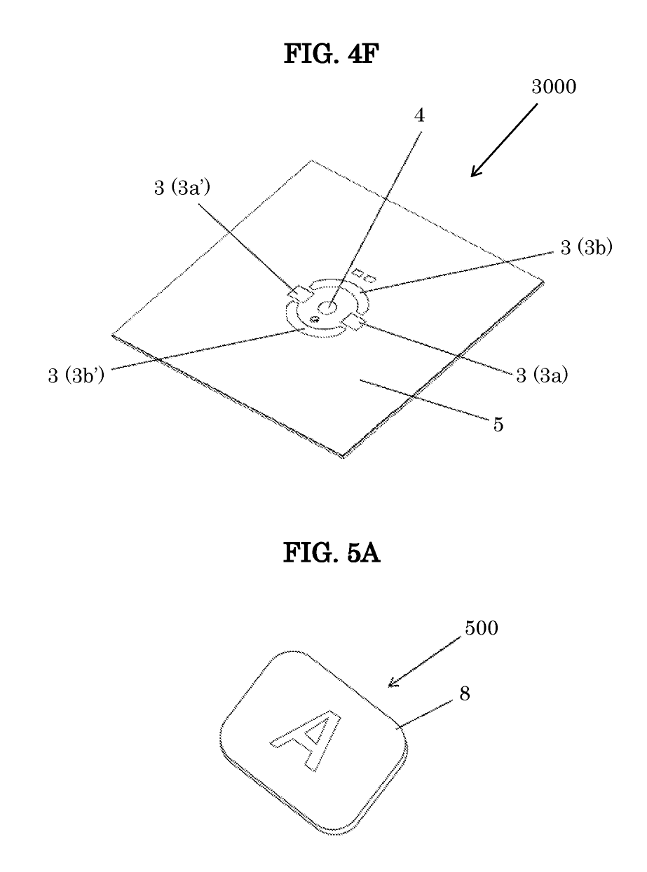

FIG. 4A shows a top perspective view of a push switch according to a fourth embodiment of the subject matter.

FIG. 4B shows a top perspective view of a push switch with a pressing member 8, which is shown in FIG. 4A, removed from the push switch. The push switch 400 in this embodiment may include a balancing member 7 shown as a second embodiment of the balancing member 7.

The push switch 400 includes a frame 10 including an upper surface 10a, a lower surface 10b, an inner surface 10c demarcating an opening, a cover 6 arranged on the upper surface 10a of the frame 10 covering the opening 10a from above to form a recessed portion 11 at the opening of the frame 10. The push switch 400 further includes a balancing member 7 including a first part 70a, a second part 70b, a linkage 70c (70c′) that connects the first part 70a and the second part 70b to be angle-variable on the linkage 70c (70c′). The second resilient member 2 is arranged in the recessed portion 11, and the first resilient member 1 is arranged across the opening 8a of the frame 10 and held at the lower surface 10 of the frame 10.

For more details, the push switch 400 in this embodiment includes a first resilient member 1, a second resilient member 2 arranged over the first resilient member 1. The first resilient member 1 includes a metallic strip. The first resilient member 1 includes a first end 1a crossing an outline 20 of the second resilient member 2 and a second end 1b crossing the outline 20 of the second resilient member 2.

The outline 20 of the second resilient member 2 includes a first arc portion 2a, a second arc portion 2a′, a first straight line portion 2b and a second straight line portion 2b′. The first resilient member 1 has a length with the first end 1a of the metallic strip of the first resilient member 1 crossing the first straight line portion 2b and the second end 1b of the metallic strip of the first resilient member 1 crossing the second straight line portion 2b′. This configuration may make it easier to electrically mount the first resilient member 1 and the second resilient member on the first electrode 3 over the second electrode 4 to obtain a double electrical contact.

The center of the first resilient member 1 and the center of the second resilient member 2 are aligned on a center axis CA of the push switch.

The balancing member 7 may support the pressing member 8 to be balanceable when a pressing force is applied to the pressing member 8 from above. The balancing member 7 may support the pressing member not to tilt. The balancing member 7 in this embodiment includes a first part 70a and a second part 70b. The first part 70a and the second part 70b of the balancing member 7 are angle-variable on the linkage 70c (70c′). The first part 70a of the balancing member 7 includes a first frame-shape. The first frame-shape includes a first side 70a-1, a second side 70a-2, a third side 70a-3, and a fourth side 70a-4 that are arranged to form an opening. The second part 70b of the balancing member 7 includes a second frame-shape that is smaller in size than the first frame-shape. The second frame-shape includes a first side 70b-1, a second side 70b-2, a third side 70b-3, and a fourth side 70b-4 to form an opening that is smaller than the opening of the first frame-shape. The second part 70b is arranged in the opening of the first part 70a. A first linkage 70c connects a center of a first side 70a-1 of the first frame-shape and a center of a first side 70b-1 of the second frame 70b, and a second linkage 70c′ connects a center of a second side 70a-2 of the first frame-shape and a center of a second side 70b-2 of the second frame-shape 70b. The second frame 70b may be pivotable on the first linkage 70c and the second linkage 70c′ in a condition that the balancing member 7 is a part and before being attached to the frame 10, the substrate 5, and/or the pressing member 8 in a push switch.

The first side 70a-1 of the first frame-shape and the first side 70b-1 of the second frame-shape are positioned adjacent to each other. The second side 70a-2 of the first frame-shape and the second side 70b-2 of the second frame-shape are positioned adjacent to each other. The first linkage 70c and the second linkage 70c′ are arranged on a straight line 1-1.

In this embodiment, the frame 10 includes a first supporting portion 110a and a second supporting portion 110b at a first side of the frame 10. The frame 10 includes a third supporting portion 110c and a fourth supporting portion 110d at a second side that is an opposite side of the first side of the frame 10. The first supporting portion 110a and the second supporting portion 110b of the frame 10 supports the fourth side 70a-4 of the first frame-shape of the first part 70a of the balancing member 7. The third supporting portion 110c and the fourth supporting portion 110d support the third side 70b-3 of the second frame-shape of the second part 70b of the balancing member 7.

The third side 70a-3 of the first frame-shape of the first part 70a of the balancing member 7 may support a pressing member 8. The fourth side 70b-4 of the second frame of the second part 70b of the balancing member 7 may support at the pressing member 8.

FIG. 4C shows a bottom perspective view of a push switch, which is shown in FIG. 4B.

FIG. 4D shows a cross-sectional view of a push switch taken along a straight line shown in FIG. 4B.

FIG. 4E shows a bottom perspective view of a push switch, with the balancing member 7 removed from the push switch 400 shown in FIG. 4C. The frame 111 may include a recessed portion 111 to receive a light-emitting element 9 that may be mountable on a substrate 5.

FIG. 4F a top perspective view of a substrate 5, on which the push switch according to the second embodiment is mountable. The substrate 5 may belong to an electronic device 3000. The electronic device may be a computer with a keyboard, for example. The push switch of this embodiment may be arranged to be a key and/or a part of key of the computer's keyboard.

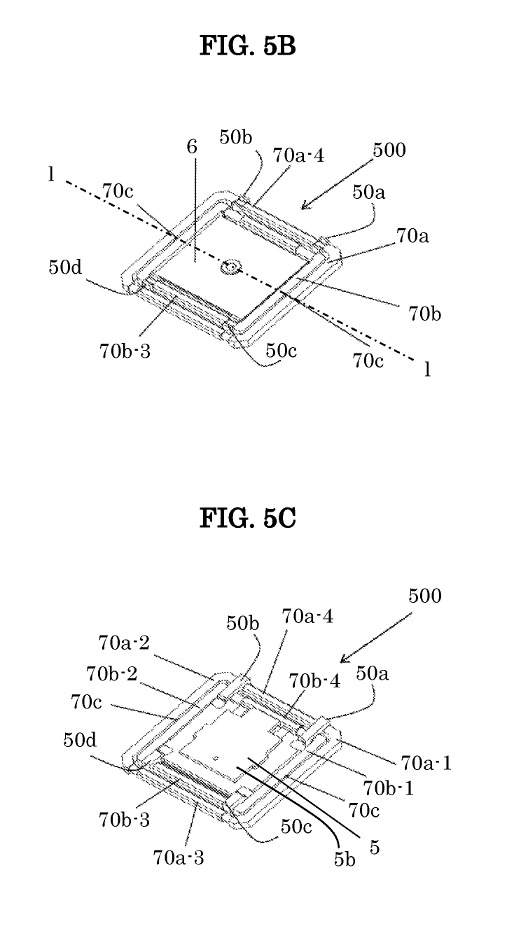

FIG. 5A shows a top perspective view of a push switch according to a fifth embodiment of the subject matter. In this embodiment, the push switch 500 may include a substrate 5. The push switch 500 includes a substrate 5 including a first electrode 3, a second electrode 4, and a recessed portion. The configuration of the substrate 5 in this embodiment can be referred to the substrate 5 shown FIG. 3D-FIG. 3F. The push switch 500 further includes a cover 6 that is arranged on the upper surface 5a of the substrate 5 and that covers the recessed portion from above, and a balancing member 7. The balancing member 7 in this embodiment has a different configuration from the configuration of the balancing member shown in FIG. 2B-2D and FIG. 3B-3D. The balancing member 7 in this embodiment includes a first part 70a, a second part 70b, a linkage that connects the first part 70a and the second part 70b to be angle-variable on the linkage. For more details, there are a first linkage 70c and a second linkage 70c′ connect the first part 70a and the second part 70b to be angle-variable on the first linkage 70c and the second linkage 70c′ that are arranged on a straight line 1-1.

The second resilient member 2 is arranged in the recessed portion of the substrate 5. The second resilient member 2 is electrically arranged on the first electrode 3 over the first resilient member 1 that is electrically arranged on the first electrode 3 over the second electrode 4. The first resilient member 1 is electrically arranged in the recessed portion of the substrate 5 under the second resilient member 2. The substrate 5 in this embodiment further includes a supporting portion to support the balancing member 7.

For more details, the substrate 5 includes a first supporting portion 50a, a second supporting portion 50b, a third supporting portion 50c, and a fourth supporting portion 50d. The push switch 500 further includes a first resilient member 1 arranged on a first electrode 3 over a second electrode 4, and the second resilient member 2 that is arranged on the first electrode 3 and that covers the first resilient member 1 except the first end 1a of the metallic strip of the first resilient member 1 and the second end 1b of the metallic strip of the first resilient member 1 that is arranged over the second electrode 4. The first frame-shape of the first part 70a is held by the first supporting portion 50a and the second supporting portion 50b of the substrate 5 at the fourth side 70a-4 of the first frame-shape of the first part 70a. The second frame-shape of the second part 70b is held by the third supporting portion 50c and the fourth supporting portion 50d of the substrate 5 at the third side 70b-3 of the second frame-shape of the second part 70b. A pressing member 8 may be arranged above the cover 6 and the second resilient member 2. The first frame-shape of the first part 70a of the balancing member 7 may be connected to the pressing member 8 at the third side 70a-3 of the first frame-shape of the first part 70a. The second frame-shape of the second part 70b of the balancing member 7 may be connected to the pressing member 8 at the fourth side 70b-4 of the second frame-shape of the second part 70b.

FIG. 5B shows a top perspective view of a push switch, with a pressing member 8, which is shown in FIG. 5A, removed from the push switch 500. In this embodiment, the push switch 500 may include a balancing member 7. The balancing member 7 includes a first part 70a, a second part 70b, and a linkage 70c (70c′) connecting the first part 70a and the second part 70b. The first part 70a and the second part 70b of the balancing member 7 are angle-variable on the linkage 70c (70c′).

FIG. 5C shows a bottom perspective view of a push switch 500, shown in FIG. 5B. Regarding the configuration inside the cover 6 and the substrate 5 of the switch 500, refer to FIG. 3D to FIG. 3F and corresponding explanation.

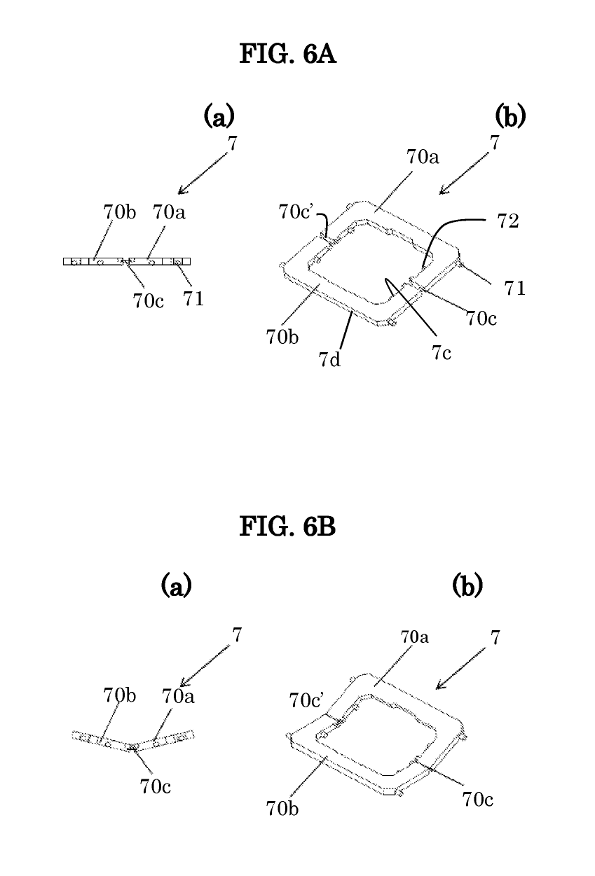

FIG. 6A shows a configuration of a balancing member 7 included in the push switch 200 according to the second embodiment of the subject matter. Also, the balancing member 7 shown in FIG. 6A is included in the push switch 300 shown in the third embodiment. The balancing member 7 shown in FIG. 6A and FIG. 6B may be made of a resin, for example. FIG. 6A shows the configuration of the balancing member 7 in a condition that a pressing force is applied to the balancing member 7 through a pressing member 8 that is arranged above the balancing member 7. For more details, the first part 70a of the balancing member 7 and the second part 70b of the balancing member 7 are configured to be flat to each other when the pressing member 8 is pressed down. FIG. 6A (a) shows a side view of the balancing member 7. FIG. 6A (b) shows a top perspective view of the balancing member 7, showing the first part 70a, the second part 70b, and a linkage 70c (70c′) that connects the first part 70a and the second part 70b. The first part 70a of the balancing member 7 includes a U-shape. The second part 70b of the balancing member 7 includes a U-shape. The first part 70a of the balancing member 7 and the second part 70b of the balancing member 7 are connected by the linkage 70c (70c′) to form a frame-shape with an opening 70d.

FIG. 6B shows the configuration of the balancing member 7 that is in a condition free from a pressing force that is applicable to the balancing member 7 through the pressing member 8 from above. FIG. 6B (a) shows a side view of the balancing member 7, showing the first part 70a and the second part 70b tilting with an angle on the linkage 70c (70c′). FIB. 6A (b) shows a top perspective view of the balancing member. The balancing member 7 in this embodiment may include one or more projections at an inner surface 7c of the frame-shape to support and/or hold a frame 10 and/or one or more projection at an outer peripheral 7d surface of the frame-shape to support and hold the cover 6. The frame 10 may include a hole 55 to receive the projection 72 at the inner surface 7c of the balancing member 7. The cover 6 may include a hole to receive the projection 72 of the balancing member 7.

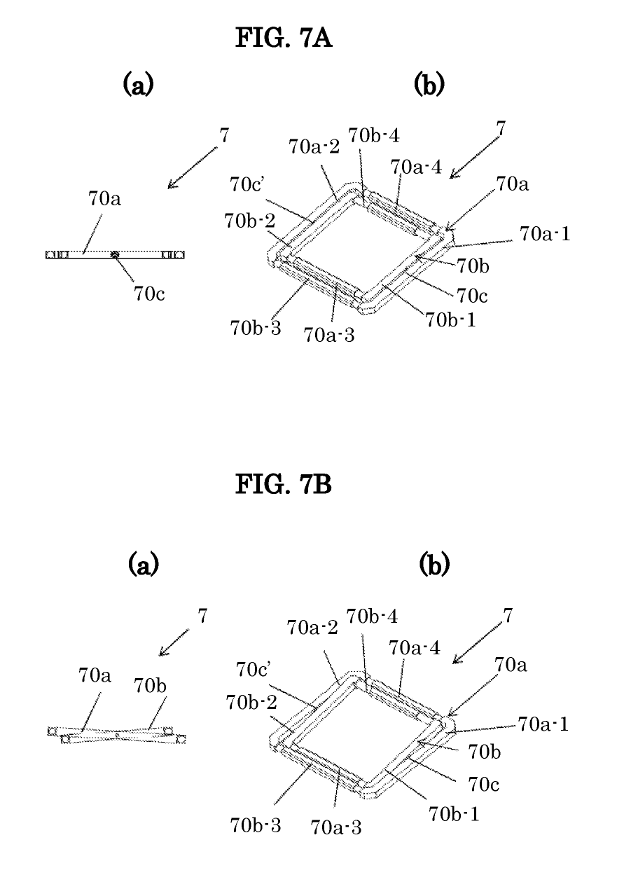

FIG. 7A shows a configuration of a balancing member 7 included in the push switch 400 according to the fourth embodiment of the subject matter. Also, the balancing member 7 shown in FIG. 7A is included in the push switch 500 according to the fifth embodiment of the subject matter. The balancing member 7 shown in FIG. 6A and FIG. 6B may include a metallic member, for example. FIG. 7A shows the configuration of the balancing member 7 in a condition that a pressing force is applied to the balancing member 7 through a pressing member 8 that is arranged above the balancing member 7. For more details, the first part 70a of the balancing member 7 and the second part 70b of the balancing member 7 are configured to be flat to each other when the pressing member 8 is pressed down from above. FIG. 7A (a) shows a side view of the balancing member 7, showing the first part 70a and the linkage that connects the first part 70a and the second part 70b that is smaller in size than the first part 70a and positioned inside the first part 70a that includes a first frame-shape. FIG. 7A (b) shows a top perspective view of the balancing member 7, showing that the first part 70a includes a first frame-shape, the second part 70b includes a second frame-shape, and the linkage. The linkage arranged at two points 70c, 70c′ that are positioned on a straight line 1-1 connect the first part 70a and the second part 70b of the balancing member 7 angle-variably on the linkage at the two points 70c, 70c′. FIG. 7B shows the configuration of the balancing member 7 that is in a condition free from a pressing force that is applicable to the balancing member 7 through the pressing member 8 from above. FIG. 7B (a) shows a side view of the balancing member 7 and FIG. 7B (b) shows a top perspective view of the balancing member 7, showing the first part 70a and the second part 70b tilting with an angle on the linkage 70c (70c′). The angle may differ depending on a size of the push switch, a keystroke or a pressing force of the push switch, for example.

Furthermore, while certain embodiments of the present inventive subject matter have been illustrated with reference to specific combinations of elements, various other combinations may also be provided without departing from the teachings of the present inventive subject matter. Thus, the present inventive subject matter should not be construed as being limited to the particular exemplary embodiments described herein and illustrated in the Figures, but may also encompass combinations of elements of the various illustrated embodiments.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

What is claimed is:

1. A component comprising:
a frame comprising an upper surface, a lower surface, and an inner surface demarcating an opening;
a cover arranged on the upper surface of the frame and covering the opening from above to form a recessed portion at the opening of the frame;
a first resilient member; and
a second resilient member arranged in the recessed portion at the opening of the frame to be over the first resilient member that is arranged across the opening of the frame and held by the frame.

2. The component according to claim 1,
wherein the first resilient member and the second resilient member are different from each other in shape and/or size.

3. The component according to claim 1,
wherein the first resilient member comprises a metallic strip, and the metallic strip of the first resilient member comprises a first end crossing an outline of the second resilient member and a second end crossing the outline of the second resilient member.

4. A push switch comprising:
a first resilient member; and
a second resilient member arranged over the first resilient member,
wherein the first resilient member comprises a metallic strip, and
the metallic strip of the first resilient member comprises a first end crossing an outline of the second resilient member and a second end crossing the outline of the second resilient member.

5. The push switch according to claim 4,
wherein the outline of the second resilient member comprises a first arc portion, a second arc portion, a first straight line portion, and a second straight line portion,
the first end of the metallic strip of the first resilient member crosses the first straight line portion of the outline of the second resilient member, and
the second end of the metallic strip of the first resilient member crosses the second straight line portion of the outline of the second resilient member.

6. The push switch according to claim 4,
wherein the center of the first resilient member and the center of the second resilient member are aligned on a center axis of the push switch.

7. The push switch according to claim 5,
wherein the first resilient member is arranged on a first electrode over a second electrode, and the second resilient member is arranged on the first electrode and covers the first resilient member except the first end of the metallic strip of the first resilient member and the second end of the metallic strip of the first resilient member that is arranged over the second electrode.

8. The push switch according to claim 4 further comprising:
a frame comprising an upper surface, a lower surface, an inner surface demarcating an opening; and
a cover arranged on the upper surface of the frame and covering the opening from above to form a recessed portion at the opening of the frame,
wherein the second resilient member is arranged in the recessed portion, and the first resilient member is arranged across the opening of the frame and held by the frame.

9. A push switch comprising:
the component of claim 3;
a substrate including a first electrode and a second electrode,
the first resilient member of the component is arranged on the first electrode over the second electrode, and the second resilient member of the component is arranged on the first electrode and covers the first resilient member except the first end of the metallic strip of the first resilient member and the second end of the metallic strip of the first resilient member that is arranged over the second electrode.

10. The push switch according to claim 9 further comprising:
a pressing member arranged above the second resilient member.

11. The push switch according to claim 8 further comprising:
a light-emitting element arranged adjacent to the cover.

12. The push switch according to claim 8, wherein the cover comprises a light-transmitting member.

13. The push switch according to claim 7 further comprising:
a substrate comprising electrodes including the first electrode and the second electrode.

14. The push switch according to claim 13 further comprising:
a light-emitting element electrically connected to the substrate.

15. An electronic device comprising:
the component of claim 1; and
a substrate comprising the first electrode and the second electrode,
wherein the first resilient member of the component is arranged on a first electrode over a second electrode of the substrate, and the second resilient member of the component is arranged on the first electrode and covers the first resilient member except the first end of the metallic strip of the first resilient member and the second end of the metallic strip of the first resilient member that is arranged over the second electrode.

16. A push switch comprising:
the component of claim 3;
the first resilient member of the component arranged on a first electrode over a second electrode;
a second resilient member of the component arranged on the first electrode over the first resilient member that is arranged over the second electrode; and
a pressing member arranged above the second resilient member to apply a pressing force to the second resilient member and the first resilient member for a double electrical contact to the first electrode and the second electrode.

17. A push switch comprising:
the component of claim 1;
a frame comprising an upper surface, a lower surface, an inner surface demarcating an opening; and
a balancing member comprising a first part, a second part, a linkage that connects the first part and the second part to be angle-variable on the linkage,
wherein the frame further comprises a supporting portion to support the balancing member.
